(19) United States
(12) Patent Application Publication
(10) Pub. No.: US 2026/0015963 A1
(43) Pub. Date: Jan. 15, 2026

(54) INTEGRATED COOLANT MODULE

(71) Applicant: Hanon Systems, Daejeon (KR)

(72) Inventors: Jungbum CHOI, Daejeon (KR); Gwang Ok KO, Daejeon (KR); Seong Woo JEONG, Daejeon (KR)

(73) Assignee: Hanon Systems, Daejeon (KR)

(21) Appl. No.: 18/995,748

(22) PCT Filed: Jul. 11, 2023
(86) PCT No.: PCT/KR2023/009869

§ 371 Date: Jan. 16, 2025

(30) Foreign Application Priority Data
Jul. 18, 2022 (KR) 10-2022-0088135

(51) Int. Cl. F01P 7/14; F01P 5/10

(52) U.S. Cl. CPC F01P 7/14; F01P 5/10; F01P 2007/146

(57) ABSTRACT

The present invention relates to an integrated coolant module applied to a vehicle cooling system, and more particularly, to an integrated coolant module, in which a reservoir tank is formed to have a vertically symmetric structure, and a valve is coupled to a lateral surface of the reservoir tank, thereby improving spatial utilization and working convenience.

### TECHNICAL FIELD

The present invention relates to an integrated coolant module applied to a vehicle cooling system, and more particularly, to an integrated coolant module, in which a reservoir tank is formed to have a vertically symmetric structure, and a valve is coupled to a lateral surface of the reservoir tank, thereby improving spatial utilization and working convenience.

### BACKGROUND ART

Recently, there has been a need to develop environmental-friendly vehicles, which may be substantially substituted for internal combustion engine vehicles, in order to improve energy efficiency and cope with environmental pollution. The environmental-friendly vehicles broadly include an electric or hydrogen vehicle that uses a battery or a fuel cell as an energy source, and a hybrid vehicle that operates by using an engine and a battery. The environmental-friendly vehicle further includes not only an engine cooling system configured to manage a process of cooling/heating the engine but also a separate electrical component cooling system configured to manage heat of electrical components such as an electric motor.

The electrical component cooling system mainly cools an electrical component, an actuator, an HSG (hybrid start and generator), and the like by using a coolant. The electrical component is structured to heat the battery in cold weather by allowing the coolant to bypass a radiator through a bypass circuit and allowing waste heat of a PE component (power electronics) to pass through the battery.

The electrical component cooling system of the environmental-friendly vehicle needs to satisfy various uses such as heating, cooling, and waste heat recovery from a plurality of water supply components. However, because of a limitation in layout space in the vehicle, there may occur problems in that difficulty in disposing the components, designing a hose route, and connecting the components and the hose increases, a large number of processes are required to mount and connect the components and the hose individually in order to mount the components in the vehicle, resistance increases at the coolant side because of a complicated route, and a high load is applied to a water pump.

FIG. 1 is a view schematically illustrating a coolant module of an electrical component cooling system in the related art. A coolant module 2 in the related art may have a structure in which a valve 4 is coupled to a lower portion of a reservoir tank 3. An internal space of the reservoir tank 3 is divided into a first space 31 and a second space 32 by a partition wall 30. In this case, it is easiest to manufacture the reservoir tank 3 with a symmetric structure with respect to the partition wall 30 so that the first space 31 and the second space 32 have the same coolant accommodation capacity. However, as illustrated, because a package space in the vehicle is changed by a vehicle hood line HL, it is difficult to design the symmetric structure in which the first space 31 and the second space 32 have the same capacity and the same structure. Further, because of a position of a coolant injection port 35 of the reservoir tank 3, there is a limitation in increasing a height of the reservoir tank 3.

In addition, in the case of a connection structure between the reservoir tank 3 and the valve 4, the valve 4 is generally coupled to the lower portion of the reservoir tank 3. However, there is a problem in that a height of the coolant module 2 is increased, and the coolant module 2 occupies a large space. Further, there is a problem in that because the valve 4 is provided on the lower portion of the reservoir tank 3, it is difficult to connect a hose when the coolant module 2 is installed in the vehicle, which degrades workability or the like.

### DOCUMENT OF RELATED ART

(Patent Document) Korean Patent No. 10-1765578 (registered on Aug. 1, 2017)

### DISCLOSURE

### Technical Problem

The present invention has been made in an effort to solve the above-mentioned problem, and an object of the present invention is to provide an integrated coolant module capable of improving spatial utilization and working convenience.

### Technical Solution

An integrated coolant module according to an example of the present invention includes: a reservoir tank having a hollow internal space that accommodates a coolant, the reservoir tank including a plurality of partition regions separated by a partition wall in the internal space; and a component coupled to one side of the reservoir tank and including at least one of a valve and a pump, in which at least one of the plurality of partition regions in the reservoir tank communicates directly with the component, and another partition region communicates with the component while penetrating a region that communicates directly with the component.

The plurality of partition regions may include a first chamber and a second chamber, the component may be disposed on a lateral surface of one side of the reservoir tank that is a lateral surface of one side of the first chamber.

An assembling surface between the component and the reservoir tank may be disposed in parallel with the partition wall.

Coolant inlet ports, through which the coolant is introduced, and coolant discharge ports may be provided on the first chamber and the second chamber, the coolant discharge port of the first chamber may be formed on a lateral surface of one side of the first chamber and connected directly to the component, and the coolant discharge port of the second chamber may be connected to the component through a connection flow path extending from the corresponding coolant discharge port.

The connection flow path may be disposed to traverse an internal space of the first chamber.

The connection flow path may be disposed outside the reservoir tank.

The first chamber may be disposed at one side based on the partition wall and formed in an elongated shape, and the second chamber may be disposed at the other side based on the partition wall and formed in an elongated shape.

The reservoir tank may have at least a partial region having a height that decreases forward from a rear side.

An upper surface of the region of the reservoir tank in which the height decreases forward from the rear side may be formed in a curved shape.

An upper surface of the region of the reservoir tank in which the height decreases forward from the rear side may be formed in a straight shape.

At least a part of an upper surface of the reservoir tank may be formed along a hood line of a vehicle.

A single coolant injection port may be provided at a rear side of an upper portion of the reservoir tank.

The first chamber and the second chamber may be formed symmetrically with respect to the partition wall.

An upper portion of the partition wall may have a penetrated structure, and the first chamber and the second chamber may communicate with each other through the penetrated upper portion of the partition wall.

A single coolant injection port may be provided on an upper portion of the reservoir tank, and the single coolant injection port may be disposed on a vertically upper portion of the partition wall.

### Advantageous Effects

According to the present invention, the reservoir tank has the vertically symmetric structure, and the valve is coupled to the lateral surface of the reservoir tank, such that it is easy to design the chambers having the same capacity in the reservoir tank. It is possible to freely design the shape of the reservoir tank in the forward/rearward direction while satisfying the above-mentioned configuration, such that the vehicle hood line may be optimally utilized. The valve is exposed in the desired direction, such that the workability may be improved when the hose or the like is connected when the valve is installed in the vehicle.

### DESCRIPTION OF DRAWINGS

FIG. 1 is a view schematically illustrating a coolant module of an electrical component cooling system in the related art.

FIG. 2 is a view illustrating an integrated coolant module according to an example of the present invention when viewed from the lateral side.

FIG. 3 is a view illustrating the integrated coolant module in FIG. 2 when viewed from the top side.

FIG. 4 is a view for explaining another example of a connection flow path.

### MODE FOR INVENTION

Hereinafter, the present invention will be described with reference to the accompanying drawings.

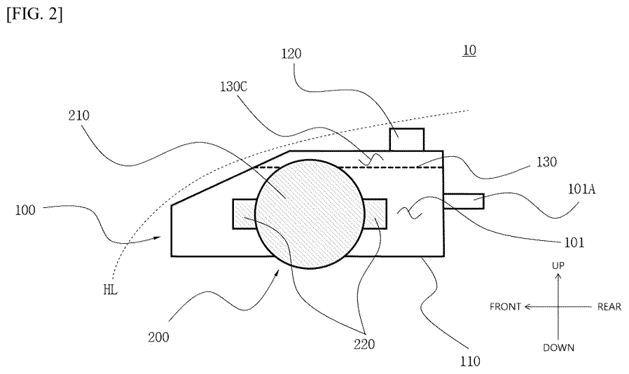

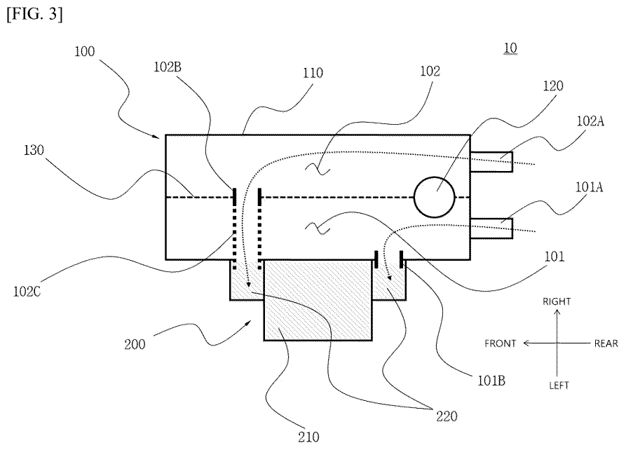

FIG. 2 is a view illustrating an integrated coolant module according to an example of the present invention when viewed from the lateral side, and FIG. 3 is a view illustrating the integrated coolant module in FIG. 2 when viewed from the top side. As illustrated, an integrated coolant module 10 of the present invention includes a reservoir tank 100 and a component 200.

The reservoir tank 100 accommodates and stores a coolant therein. The reservoir tank 100 includes a tank body 110 corresponding to an outer peripheral housing, a coolant injection port 120 provided on an upper portion of the tank body 110 and configured to inject the coolant into an internal space of the tank body 110, and a partition wall 130 provided in the internal space of the tank body 110. Further, the internal space of the tank body 110 includes a first chamber 101 and a second chamber 102 separated by the partition wall 130.

Coolant inlet ports, through which the coolant is introduced, and coolant discharge ports are provided on the first chamber 101 and the second chamber 102. In the drawings, the coolant inlet port of the first chamber 101 is illustrated as a first coolant inlet port 101A, the coolant discharge port of the first chamber 101 is illustrated as a first coolant discharge port 101B, the coolant inlet port of the second chamber 102 is illustrated as a second coolant inlet port 102A, and the coolant discharge port of the second chamber 102 is illustrated as a second coolant discharge port 102B. The coolant inlet port and the coolant discharge port may each have a through-hole structure that penetrates the tank body 110 or the partition wall 130. At least some of the coolant inlet ports and the coolant discharge ports may each have a pipe structure extending to a predetermined degree therefrom.

An upper portion of the partition wall 130 may have a penetrated structure 130C. For example, the partition wall 130 may have a predetermined height defined upward from a bottom of the tank body 110. Therefore, an upper end of the partition wall 130 and an upper surface of the tank body 110 may be spaced apart from each other at a predetermined interval. Further, as described above, the first chamber 101 and the second chamber 102 may communicate with each other through the penetrated upper portion 130C of the partition wall 130, i.e., an upper portion of the partition wall 130 having a predetermined height.

In this case, the coolant in the first chamber 101 and the coolant in the second chamber 102 may circulate through different cooling circuits and thus have different temperature distributions. For example, the coolant in the first chamber 101 may flow along a PE cooling circulation line for cooling a PE component, and the coolant in the second chamber 102 may flow along a battery cooling circulation line for cooling a battery. In this case, because a temperature range of a main operation region of the PE component is higher than that of the battery, a temperature of the coolant in the first chamber 101, which has circulated through the PE cooling circulation line and has been introduced again, may be higher than a temperature of the coolant in the second chamber 102 that has circulated through the battery cooling circulation line and has been introduced again. As described above, it is not preferable that the coolants in the two chambers are mixed in case that the temperature distributions of the coolants in the two chambers are different. A height of the partition wall 130 (i.e., a lowest height of the penetrated upper portion of the partition wall) is designed to be higher than a highest coolant level preset in the reservoir tank 100 so that the coolant in one side chamber does not flow to the other side chamber. In this case, the preset lowest coolant level and the preset highest coolant level may each refer to the preferable preset amount of the coolant accommodated and stored in the reservoir tank and be indicated by a line shape formed on an inner or outer surface of a tank body.

The coolant injection port 120 may be configured as a single coolant injection port 120, and the single coolant injection port 120 may be disposed on a vertically upper portion of the partition wall 130 having the above-mentioned structure. That is, coolant injection ports may be respectively provided on the chambers to supply the coolant to the first chamber 101 and the second chamber 102, but this configuration causes an increase in the number of components and the inconvenience in supplying the coolant. Therefore, the single coolant injection port may be provided. In case that the coolant injection port 120 is disposed on the vertically upper portion of the partition wall 130, the coolant injected through the corresponding coolant injection port 120 may be distributed to the first chamber 101 and the second chamber 102. Therefore, the single coolant injection port 120 may be provided in the present invention by using this configuration.

The component 200 includes at least one of a valve and a pump. The component 200 may refer to a valve, a pump, or a coolant control module configured by integrating the valve and the pump. In the present invention, the configuration in which the component 200 is the valve will be described. Hereinafter, the valve 200 will be described instead of the component 200.

The valve 200 may be a multidirectional motorized valve that serves to control the flow path of the coolant. The valve may include a valve main body 210 and a valve-reservoir connection part 220. The reservoir tank 100 and the valve 200 may be fluidly connected to each other through the valve-reservoir connection part 220. More specifically, the first chamber 101 and the second chamber 102 are connected to the valve 200. In this case, the first coolant discharge port 101B of the first chamber 101 and the second coolant discharge port 102B of the second chamber 102 may be connected directly to the valve-reservoir connection part 220.

That is, the integrated coolant module 10 of the present invention has the structure in which the reservoir tank 100 and the valve 200 are coupled to each other, and the reservoir tank 100 and the valve 200 are connected directly to each other without a connection member such as a separate hose. Therefore, the miniaturization may be implemented by modularizing the components.

With reference back to FIGS. 2 and 3, in the integrated coolant module 10 of the present invention, the partition wall 130 is disposed in a forward/rearward direction in the internal space of the tank body 110. That is, the partition wall 130 is structured to be elongated in the forward/rearward direction. Further, the first chamber 101 is disposed at a left side of the internal space (i.e., one side based on the partition wall) and elongated in the forward/rearward direction. The second chamber 102 is disposed at a right side of the internal space (i.e., the other side based on the partition wall) and elongated in the forward/rearward direction. Further, the valve 200 is disposed at the left side of the reservoir tank 100, i.e., the left side of the first chamber 101. That is, an assembling surface of the valve 200 with respect to the reservoir tank 100 is disposed in parallel with the partition wall 130, and the valve 200 is coupled to a lateral surface of the reservoir tank 100.

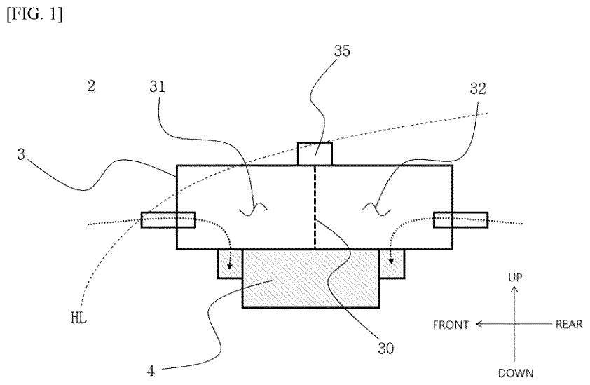

In the case of the coolant module 2 in the related art in FIG. 1, the valve 4 is positioned on the lower portion of the reservoir tank 3, which makes it inconvenient to connect a hose or the like. In contrast, according to the present invention, the valve 200 is positioned on the lateral surface of the reservoir tank 100, and a degree to which the valve 200 is exposed is increased, such that workability may be improved when a hose or the like is connected when the coolant module 10 is installed in the vehicle.

Further, because the first chamber 101 and the second chamber 102 are separated at the left and right sides, the first chamber 101 and the second chamber 102 may have the same internal capacity even though the reservoir tank 100 is not symmetric in the forward/rearward direction. Therefore, as described below, a shape of the reservoir tank 100 may be freely changed to suit the vehicle hood line HL.

Meanwhile, the first chamber 101 may be connected directly to the valve 200 because the coolant discharge port 101B is formed at the left side of the first chamber 101. However, the second chamber 102 is spaced apart from the valve 200, and the first chamber 101 is positioned between the second chamber 102 and the valve 200, such that it is difficult to connect the second chamber 102 directly to the valve 200. In order to cope with this difficulty, the present invention employs a configuration of a connection flow path 103B. That is, the integrated coolant module 10 of the present invention may further include the connection flow path 103B extending from the coolant discharge port 102B of the second chamber 102, and the second chamber 102 may be connected to the valve through the corresponding connection flow path 103B.

As illustrated in FIG. 3, the connection flow path 103B may be disposed to traverse the internal space of the first chamber 101. That is, the connection flow path 103B may be disposed in the internal space of the first chamber 101. Because the connection flow path is disposed and accommodated in the internal space of the first chamber as described above, it is possible to efficiently reduce the space occupied by the connection flow path. In the present example, the connection flow path 103B may be manufactured by molding and integrated with the tank body 110. In this case, the connection flow path may be formed on the bottom of the tank body 110. The molding manufacturing is advantageous.

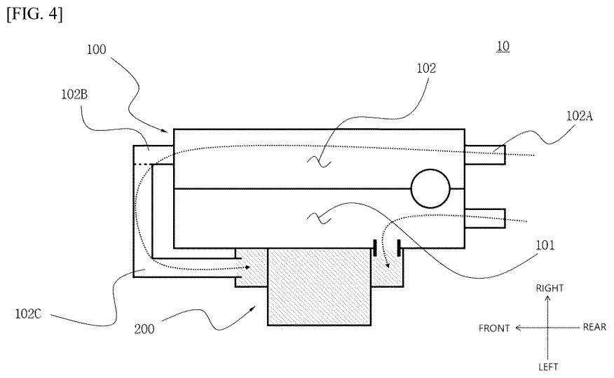

On the contrary, the connection flow path 103B may be disposed outside the reservoir tank 100. FIG. 4 is a view for explaining another example of the connection flow path. As illustrated, the connection flow path 103B of the present example may be disposed outside the reservoir tank 100, unlike the previous example. In the present example, the connection flow path 103B may be configured as a separate hose. Further, in the previous example, the coolant discharge port 102B of the second chamber is formed on the partition wall 130. On the contrary, in the present example, the coolant discharge port 102B of the second chamber may be formed on the tank body 110. The present example advantageously has a simple structure and is conveniently manufactured in comparison with the previous example.

Further, although not illustrated separately, the connection flow path 103B may have a structure in which a height thereof decreases from the second chamber 102 toward the valve 200. This structure may assist in allowing the coolant to flow smoothly from the second chamber 102 to the valve 200. In addition, the connection flow path 103B may be integrated with the coolant discharge port 102B of the second chamber. Alternatively, the connection flow path 103B may be manufactured separately from the coolant discharge port 102B of the second chamber and coupled to the coolant discharge port 102B of the second chamber.

With reference back to FIG. 2, as illustrated, the reservoir tank 100 is configured such that a height of at least a partial region decreases forward from the rear side. That is, an upper surface of the reservoir tank 100 may be structured to fall forward from the rear side. Therefore, the hood line HL of the vehicle may be maximally utilized. FIG. 2 illustrates the reservoir tank 100 having a shape in which a height thereof constantly decreases forward from a predetermined position of a center of the reservoir tank 100. Alternatively, the upper surface of the reservoir tank 100 may be formed in a curved shape along the hood line of the vehicle, or the reservoir tank 100 may be formed in a shape in which a height thereof decreases forward from the rear side as a whole.

Further, as described above, the coolant injection port 120 may be configured as a single coolant injection port. In this case, the single coolant injection port 120 may be disposed at the rear side of the upper portion of the reservoir tank 100. The coolant injection port 120 protrudes upward from the tank body 110 to a predetermined degree, which may advantageously maximize the layout based on the vehicle hood line HL.

In addition, the reservoir tank 100 may have a vertically symmetric structure as a whole. Specifically, the first chamber 101 and the second chamber 102 may be structured to be symmetric with respect to the partition wall 130. Therefore, the first chamber 101 and the second chamber 102 may have the same horizontal cross-sectional area, and the first chamber 101 and the second chamber 102 may have the same volume and the same capacity. That is, in the case of the reservoir tank 3 in the related art in FIG. 1, there is difficulty in terms of design because the structure of the partition wall 30 or the shape of the tank body needs to be changed to configure the first and second spaces 31 and 32 having the same capacity. In contrast, according to the present invention, the reservoir tank merely has the vertically symmetric structure with respect to the partition wall formed in the forward/rearward direction, such that the first chamber and the second chamber may be easily configured to have the same capacity, and the highest coolant levels and the lowest coolant levels may be equally set in the two chambers, which may improve the manufacturing and using convenience.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

10: Integrated coolant module
100: Reservoir tank
110: Tank body
120: Coolant injection port
130: Partition wall
130C: Penetrated upper portion of partition wall
101: First chamber
102: Second chamber
200: Component (valve)
210: Valve main body
220: Valve-reservoir connection part
HL: Vehicle hood line

1. An integrated coolant module comprising:
a reservoir tank having a hollow internal space that accommodates a coolant, the reservoir tank comprising a plurality of partition regions separated by a partition wall in the internal space; and
a component coupled to one side of the reservoir tank and comprising at least one of a valve and a pump,
wherein at least one of the plurality of partition regions in the reservoir tank communicates directly with the component, and another partition region communicates with the component while penetrating a region that communicates directly with the component.

2. The integrated coolant module of claim 1, wherein the plurality of partition regions comprises a first chamber and a second chamber, the component is disposed on a lateral surface of one side of the reservoir tank that is a lateral surface of one side of the first chamber.

3. The integrated coolant module of claim 2, wherein an assembling surface between the component and the reservoir tank is disposed in parallel with the partition wall.

4. The integrated coolant module of claim 2, wherein coolant inlet ports, through which the coolant is introduced, and coolant discharge ports are provided on the first chamber and the second chamber, the coolant discharge port of the first chamber is formed on a lateral surface of one side of the first chamber and connected directly to the component, and the coolant discharge port of the second chamber is connected to the component through a connection flow path extending from the corresponding coolant discharge port.

5. The integrated coolant module of claim 4, wherein the connection flow path is disposed to traverse an internal space of the first chamber.

6. The integrated coolant module of claim 4, wherein the connection flow path is disposed outside the reservoir tank.

7. The integrated coolant module of claim 2, wherein the first chamber is disposed at one side based on the partition wall and formed in an elongated shape, and the second chamber is disposed at the other side based on the partition wall and formed in an elongated shape.

8. The integrated coolant module of claim 7, wherein the reservoir tank has at least a partial region having a height that decreases forward from a rear side.

9. The integrated coolant module of claim 8, wherein an upper surface of the region of the reservoir tank in which the height decreases forward from the rear side is formed in a curved shape.

10. The integrated coolant module of claim 8, wherein an upper surface of the region of the reservoir tank in which the height decreases forward from the rear side is formed in a straight shape.

11. The integrated coolant module of claim 8, wherein at least a part of an upper surface of the reservoir tank is formed along a hood line of a vehicle.

12. The integrated coolant module of claim 7, wherein a single coolant injection port is provided at a rear side of an upper portion of the reservoir tank.

13. The integrated coolant module of claim 2, wherein the first chamber and the second chamber are formed symmetrically with respect to the partition wall.

14. The integrated coolant module of claim 2, wherein an upper portion of the partition wall has a penetrated structure, and the first chamber and the second chamber communicate with each other through the penetrated upper portion of the partition wall.

15. The integrated coolant module of claim 2, wherein a single coolant injection port is provided on an upper portion of the reservoir tank, and the single coolant injection port is disposed on a vertically upper portion of the partition wall.
